(19) United States
(12) Patent Application Publication
(10) Pub. No.: US 2009/0325471 A1
(43) Pub. Date: Dec. 31, 2009

(54) DIAMOND POLISHING DISK AND MANUFACTURING METHOD THEREOF

(75) Inventors: Cheng Shiang Chou, Taipei County (TW); Hung-Ju Wang, Taipei County (TW); Chih-Chung Chou, Taiwan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: KINK COMPANY, Taipei (TW)

(21) Appl. No.: 12/483,778

(22) Filed: Jun. 12, 2009

(30) Foreign Application Priority Data
Jun. 25, 2008 (TW) 097123810

(51) Int. Cl. C09K 3/14; B24B 53/02

(52) U.S. Cl. 451/443; 51/298

(57) ABSTRACT

A diamond polishing disk and a manufacturing method thereof are described. The method includes the steps as follows. A plurality of diamond particles are disposed in an accommodation unit, and each diamond particle has at least one acute polishing end. Next, a guiding mold is supplied, in which the guiding mold has a plurality of grooves. The guiding mold is pressed on the diamond particles, such that the acute polishing ends of the diamond particles are respectively inserted in the grooves correspondingly. Next, the guiding mold is removed, and then a polymer material is injected into the accommodation unit to cover the diamond particles. The polymer material is hardened. Finally, the accommodation unit is removed, so as to finish manufacturing the diamond polishing disk.

### CROSS-REFERENCE TO RELATED APPLICATIONS

This non-provisional application claims priority under 35 U.S.C. §119(a) on Patent Application No(s). 097123810 filed in Taiwan, R.O.C. on Jun. 25, 2008 the entire contents of which are hereby incorporated by reference.

### BACKGROUND OF THE INVENTION

1. Field of the Invention

The present invention relates to a diamond polishing disk and a manufacturing method thereof, and more particularly to a diamond polishing disk capable of effectively controlling a diamond arrangement direction and a manufacturing method thereof.

2. Related Art

In recent years, with the rapid development and maturity of the integrated circuit (IC) technology, the semiconductor industry has become one of the most vigorous industries. The semiconductor products are widely applied in fields such as information, communication, consumptive electronics, industrial instruments, transportations, and national defense and space. Thus, the semiconductor industry has a great impact on electronic products, and is undoubtedly important.

In the semiconductor industry, silicon wafers have become a critical material. The silicon wafers must first go through a chemical mechanical polishing (CMP) process to have its surface flattened, and then the chips are manufactured thereon in the subsequent process, thereby enhancing the accuracy and yield of the process. As polishing pads are used in the CMP process, after long period of usage, polishing particles may fall into the gaps of the polishing pad, which reduces the efficiency of the polishing pad. Therefore, the polishing pad must be conditioned regularly to remove the residual impurities and scraps after polishing, so as to keep the polishing pad in the best state thereof. Thus, in the semiconductor industry, by reason of high hardness, diamonds are applied to a pad conditioner for conditioning the polishing pad. The pad conditioner is disk-shaped or annular-shaped, and is also referred to as the diamond disk pad conditioner.

In order to extend the service life and enhance the polishing performance of the pad conditioner, Taiwan Patent Publication No. 412461 entitled “Diamond Disk for Conditioning Wafer Polishing Pad and Manufacturing Method thereof” and U.S. Pat. No. 5,092,910 entitled “Abrasive Tool and Method for Making” have disclosed a method of making diamond particles regularly arranged in a pattern on a polishing tool by using a die hole or screen with regularly distributed holes, which replaces the conventional way of arranging the diamond particles in a random and irregular manner on the polishing tool. Moreover, Taiwan Patent Publication No. 541226 filed on Jul. 11, 2003, and entitled “Polishing Tool Having Contour Abrasive Particles and Manufacturing Method thereof” discloses a method of arranging the diamond particles uniformly at the same heights, in which the abrasive particles are spaced at a suitable distance and arranged in an abrasive particle positioning groove in a carrier, and a bonding agent is filled into the abrasive particle positioning groove, such that the abrasive particles are arranged in consistent orientations.

Taiwan Patent No. 412461 and U.S. Pat. No. 5,092,910 may achieve the purpose of uniformly arranging the diamond particles with a suitable distance. However, the mesh size of the die hole or the screen is greater than the diameter of the diamond particles, such that the diamond particles can be only arranged regularly according to the positions of the meshes, but the orientations of the arranged diamond particles are hard to control. Therefore, the heights of diamond particles exposed from the diamond polishing disk are different, which may greatly affect the uniformity of polishing and service life of the diamond disk pad conditioner. Furthermore, after the diamond particles are arranged on the surface of the wafer, a brazing process is still required to make the diamond particles and the surface of the wafer firmly bonded together, thus raising the problems of substrate deformation and degradation of the diamond particles.

Further, in Taiwan Patent No. 541226, a carrier on which the diamond particles are arranged must firstly be milled with a positioning groove in a predetermined shape, and thus the manufacturing cost is increased due to the additional processing procedure on the carrier. Besides, in order to make the diamond particles be consistent in orientations, more time will be spent on laying the diamond particles, and thereby the efficiency of producing the diamond disk pad conditioner is lowered.

In the conventional methods for manufacturing the diamond disk pad conditioner, although the plurality of diamond particles may be arranged uniformly and regularly, the diamond particles cannot be consistent in orientations. Alternatively, higher cost and more manufacturing time will be spent to arrange the abrasive particles in consistent orientations. Accordingly, the conventional diamond disk pad conditioner still has many problems to be solved.

### SUMMARY OF THE INVENTION

In view of the above problems, the present invention is a diamond polishing disk capable of effectively controlling a diamond arrangement direction and a manufacturing method thereof, thereby solving limits or disadvantages in the prior art that the diamond particles are arranged in different heights with an excessively complicated process and a high cost as diamond particles are non-uniformly distributed in disordered direction orientation.

The present invention provides a manufacturing method of the diamond polishing disk, which comprises the steps as follows. Firstly, an accommodation unit is provided, a plastic material is adhered to the accommodation unit, then a plurality of diamond particles are adhered to the plastic material, and the diamond particles respectively have at least one acute polishing end raised on the plastic material. Next, a guiding mold is provided, in which a lateral side of the guiding mold has a plurality of pyramidal grooves. The guiding mold is pressed on the plurality of diamond particles, such that the acute polishing ends of the diamond particles are respectively inserted in the grooves correspondingly. Then, the guiding mold is removed, and a polymer material is injected into the accommodation unit to cover the diamond particles. The polymer material is hardened to fix the diamond particles. Finally, the accommodation unit is removed, so as to finish manufacturing the diamond polishing disk according to the present invention.

The efficacy of the present invention is that the guiding mold having the pyramidal grooves of different shapes, sizes, and angles is provided, such that the acute polishing ends of the diamond particles are inserted in the pyramidal grooves of the guiding mold, so as to provide more turning chances for the diamond particles, such that the plurality of diamond particles are uniformly arranged and have the consistent direction orientation, thereby achieving an excellent polishing effect of the diamond polishing disk.

The detailed features and advantages of the present invention are described below in great detail through the following embodiments, and the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention The description on the content of the present invention above and the description on the embodiments below are used to exemplify and explain the spirit and principle of the present invention, and provide further explanation on the claims of the present invention.

### BRIEF DESCRIPTION OF THE DRAWINGS

The present invention will become more fully understood from the detailed description given herein below for illustration only, and thus are not limitative of the present invention, and wherein:

FIGS. 1A to 1C are schematic views of a manufacturing flow of a guiding mold according to a preferred embodiment of the present invention;

FIGS. 2A to 2E are schematic views of a manufacturing flow of a diamond polishing disk according to a preferred embodiment of the present invention;

FIG. 3 is a schematic cross-sectional view of the diamond polishing disk according to the present invention;

FIG. 4A is a schematic structural view of the diamond polishing disk according to the present invention; and

FIG. 4B is a schematic structural view of the diamond polishing disk according to the present invention.

### DETAILED DESCRIPTION OF THE INVENTION

The objectives, structures, features, and functions of the present invention will become apparent from the detailed description of the embodiments given hereinafter.

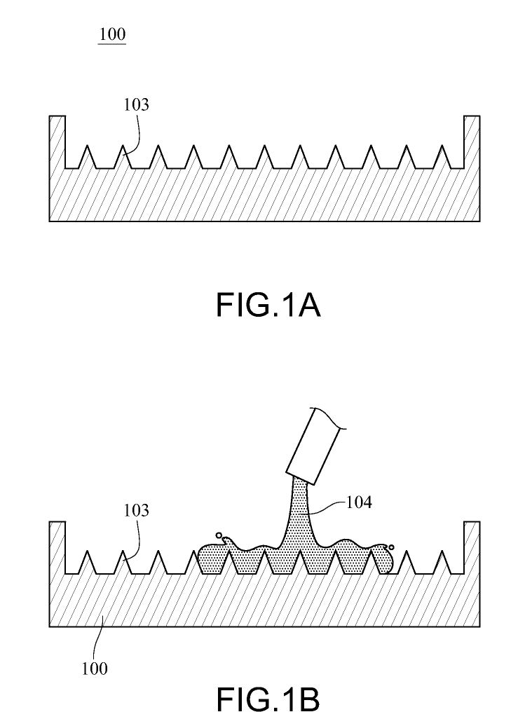

In the present invention, an arrangement direction of diamond particles of a diamond polishing disk is adjusted by a guiding mold. Firstly, referring to FIGS. 1A to 1C, schematic views of a manufacturing flow of a guiding mold 200 according to the present invention are shown. A metal mold 100 is provided (FIG 1A), the metal mold 100 has a plurality of protrusions 103, the protrusions 103 are, for example, pyramids, and the protrusions 103 are separately disposed with a fixed distance. Then, a resin material 104 is injected on the metal mold 100 to cover the protrusions 103 (FIG 1B), in which the resin material is epoxy resin. Afterwards, the resin material 104 is hardened, and is separated from the metal mold 100. The metal mold 100 has the protrusions 103, so the hardened resin material 104 may form grooves corresponding to the protrusions 103 of the metal mold. After the hardened resin material 104 is separated from the metal mold 100, the guiding mold 200 according to the present invention is formed (FIG. 1C), in which the guiding mold 200 has a plurality of grooves 201, structures of the grooves may be the pyramids, for example, triangular pyramids or quadrangular pyramids, and the pyramids may have the same side length or different side lengths. In addition, bottoms of the grooves 201 of the guiding mold are V shaped, and have an included angle being 100° to 150°. The grooves 201 have a size of 150 μm to 215 μm. In addition, the grooves 201 may have the same size or different sizes, but it is not limited to the embodiments of the present invention.

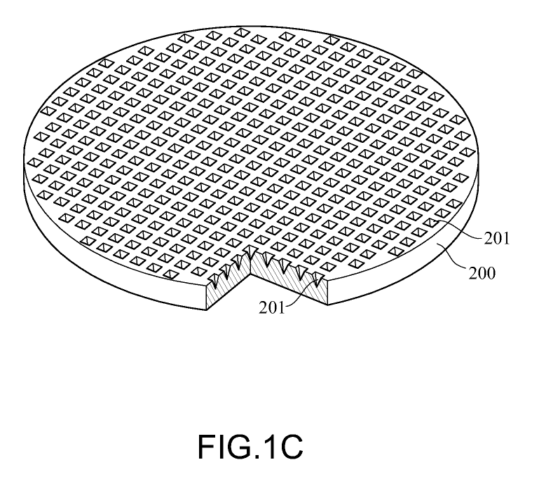

Next, referring to FIGS. 2A to 2E, schematic views of a manufacturing flow of a diamond polishing disk according to a preferred embodiment of the present invention are shown. Firstly, an accommodation unit 300 is provided, a plastic material 400 is adhered to the accommodation unit 300, and a plurality of diamond particles 500 are adhered to the plastic material 400 (FIG. 2A), in which the diamond particles 500 have a particle diameter of 250 μm to 420 μm, and the diamond particles 500 respectively have at least one acute polishing end 501 raised on the plastic material 400. Next, a guiding mold 200 is provided, and the guiding mold 200 is pressed on the diamond particles 500 (FIG. 2B), such that the diamond particles 500 are respectively inserted in the grooves 201 of the guiding mold correspondingly. The grooves 201 of the guiding mold are disposed corresponding to the diamond particles 500, so when a pressure is applied to the guiding mold 200, by reason of the grooves 201, the arrangement direction of the diamond particles 500 is changed, such that the acute polishing ends 501 of the diamond particles 500 lean against the grooves 201 and fit with V-shaped bottoms of the grooves. In this manner, the arrangement direction of the diamond particle 500 is changed. Afterwards, the guiding mold 200 is removed.

Next, a polymer material 800 is injected into the accommodation unit 300 (FIG. 2C), and covers the diamond particles 500. A material of the polymer material 800 is epoxy resin, and as the epoxy resin is used as a bonding agent for the diamond particles 500, it is possible to prevent a problem of the prior art of substrate deformation and degradation of the diamond particles by reason of a high temperature brazing process. Afterwards, the polymer material 800 is hardened to form a base 600 (FIG. 2D). Finally, the accommodation unit 300 and the plastic material 400 are removed, and the diamond polishing disk according to the present invention is formed (FIG. 2E).

It should be noted that a flatness of a surface of the base 600 formed by using the polymer material is poor, so in order to improve the entire flatness of the polishing disk and eliminate the problem that the polymer material on peripheries of the diamond particles 500 are depressed after the process, a curing glue 700 is selectively formed on the hardened base 600. The curing glue 700 is an ultraviolet (UV) glue, which may be hardened through irradiation of the UV light, thereby obtaining the diamond polishing disk having the flat surface and the diamond particles 500.

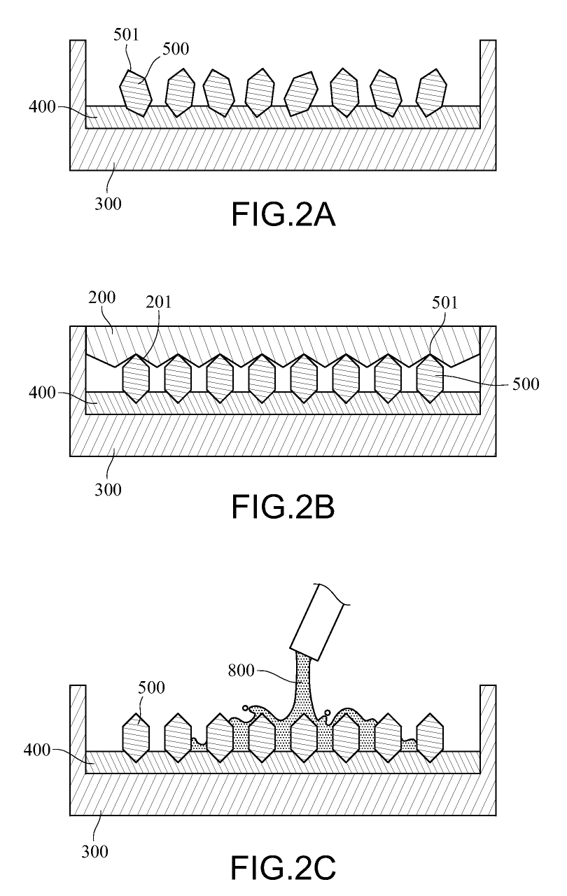

Referring to FIG. 3, a schematic cross-sectional view of the diamond polishing disk according to the present invention is shown. The diamond polishing disk has a base 600 and a plurality of diamond particles 500. The material of the base 600 is the epoxy resin. The diamond particles 500 have at least one acute polishing end 501, the diamond particles 500 are radially distributed on the base 600, and the acute polishing ends 501 are exposed from the surface of the base 600, such that the acute polishing ends 501 of the plurality of diamond particles 500 are exposed from the base 600 at the same height towards an axial direction.

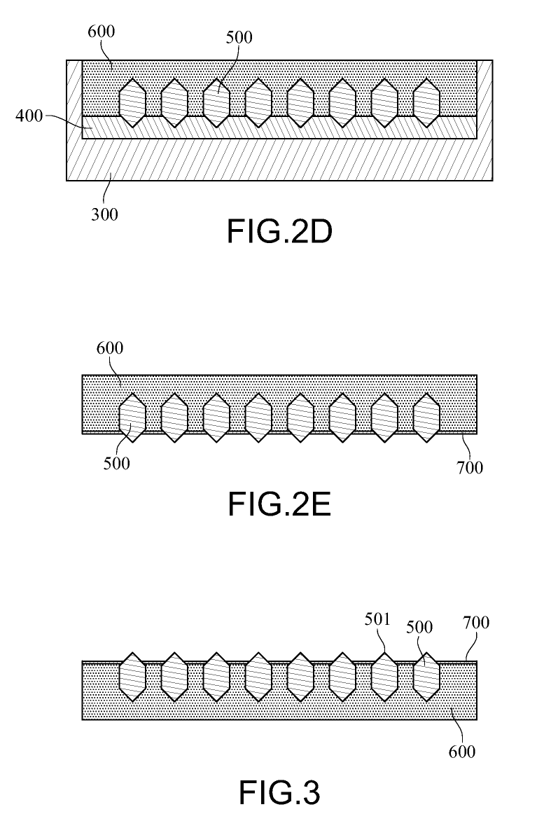

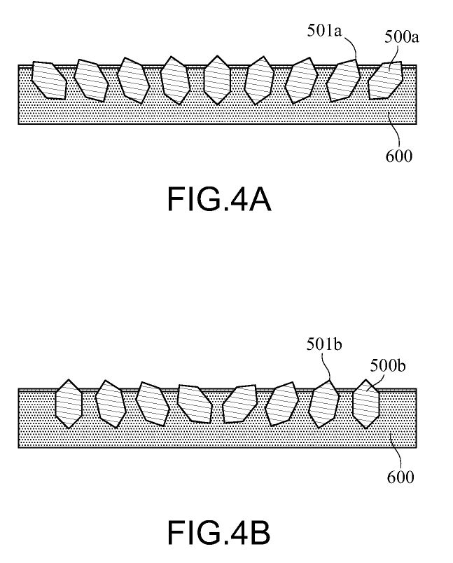

In addition, it should be noted that the diamond polishing disk according to the present invention may be formed into the diamond polishing disk having the diamond particles of different arrangement angles as shown in FIGS. 4A and 4B by changing shapes, angles, or sizes of the grooves 201 of the guiding mold 200, for example, changing the structures of the grooves 201 to the pyramid having different side lengths. Referring to FIG. 4A, a plurality of diamond particles 500a are radially distributed on the base 600, and acute polishing ends 501a of the diamond particles are increasingly inclined in concentric circles to an outer periphery sequentially by taking an axial center of the base 600 as a reference, such that the diamond polishing disk assumes a shape having a high center and a low periphery. Definitely, the inclined angles may be increasingly increased from the concentric circles to the axial center sequentially, and it is not limited to this embodiment.

In addition, the diamond polishing disk as shown in FIG. 4B may be manufactured, in which a plurality of diamond particles 500b is radially distributed on the base 600, acute polishing ends 501b of the diamond particles near the outer periphery are exposed from the base 600 towards the axial direction, the remaining diamond particles 500b are increasingly inclined in concentric circles to the axial center of the base 600 sequentially, such that the diamond polishing disk assumes a shape having a low center and a high periphery. Those skilled in the art may change the shape of the surface of the diamond polishing disk to various geometric shapes, so as to meet the demands when the diamond polishing disk is practically applied to the polishing process, and it is not limited to the embodiments of the present invention.

In the diamond polishing disk according to the present invention, a guiding mold having a plurality of grooves is provided, and the grooves are pressed on the diamond particles, such that the acute polishing ends of the diamond particles are inserted into the grooves. In this manner, the arrangement direction of the diamond particles is adjusted by the guiding mold, and the curing glue covers the base formed by using the polymer material. Therefore, by using the present invention, in addition to greatly increasing the turning chances for the diamond particles, lowering the manufacturing cost, and preventing the disadvantage in the prior art that the diamond particle orientations cannot be controlled by using a screen mesh, it is further possible to prevent the problem of substrate deformation and degradation of the diamond particles by reason of the high temperature brazing process.

What is claimed is:

1. A manufacturing method of a diamond polishing disk, comprising:
providing an accommodation unit, wherein a plurality of diamond particles are disposed in the accommodation unit, and each diamond particle has at least one acute polishing end;
providing a guiding mold, wherein the guiding mold has a plurality of grooves;
pressing the guiding mold on the diamond particles, such that the acute polishing ends of the diamond particles are respectively inserted in the grooves correspondingly;
removing the guiding mold;
injecting a polymer material into the accommodation unit and covering the diamond particles;
hardening the polymer material; and
removing the accommodation unit.

2. The manufacturing method according to claim 1, further comprising adhering a plastic material in the accommodation unit, and the acute polishing ends of the diamond particles are raised on the plastic material.

3. The manufacturing method according to claim 1, further comprising forming a curing glue on the hardened polymer material.

4. The manufacturing method according to claim 3, wherein the curing glue is an ultraviolet (UV) glue.

5. The manufacturing method according to claim 1, wherein a material of the polymer material is epoxy resin.

6. The manufacturing method according to claim 1, wherein a process of forming the grooves of the guiding mold comprises:
providing a metal mold, wherein the metal mold has a plurality of recesses;
providing a resin layer on the metal mold, and covering the recesses;
hardening the resin layer; and
separating the hardened resin layer from the metal mold, so as to obtain the guiding mold.

7. The manufacturing method according to claim 6, wherein the resin layer is epoxy resin.

8. The manufacturing method according to claim 6, wherein the grooves are pyramids.

9. The manufacturing method according to claim 8, wherein the pyramids comprise triangular pyramids or quadrangular pyramids.

10. The manufacturing method according to claim 8, wherein the pyramids have the same side length or different side lengths.

11. The manufacturing method according to claim 6, wherein an included angle is formed at bottoms of the grooves, and the included angle ranges from 100° to 150°.

12. The manufacturing method according to claim 6, wherein the grooves have a size of 150 μm to 215 μm, and the diamond particles have a particle diameter of 250 μm to 420 μm.

13. The manufacturing method according to claim 1, wherein the acute polishing ends of the diamond particles are respectively inserted in the grooves correspondingly, such that the diamond particles are turned.

14. A diamond polishing disk manufactured by the manufacturing method according to claim 1, comprising:
a polymer base; and
a plurality of diamond particles, disposed on the polymer base, and respectively having at least one acute polishing end exposed from a surface of the polymer base.

15. The diamond polishing disk according to claim 14, wherein a material of the polymer base is epoxy resin.

16. The diamond polishing disk according to claim 14, wherein the diamond particles are radially disposed on the base, and the acute polishing ends of the diamond particles are exposed from the base at the same height towards an axial direction.

17. The diamond polishing disk according to claim 14, wherein the diamond particles are radially distributed on the base, and the acute polishing ends of the diamond particles are increasingly inclined in concentric circles to an outer periphery sequentially by taking an axial center of the base as a reference, such that the diamond polishing disk assumes a shape having a high center and a low periphery.

18. The diamond polishing disk according to claim 14, wherein the diamond particles are radially distributed on the base, the acute polishing ends of the diamond particles near an outer periphery are exposed from the base towards an axial direction, and the remaining diamond particles are increasingly inclined in concentric circles to an axial center of the base sequentially, such that the diamond polishing disk assumes a shape having a low center and a high periphery.
